(19) United States
(12) Patent Application Publication
(10) Pub. No.: US 2015/0050951 A1
(43) Pub. Date: Feb. 19, 2015

(54) Method And System For Managing Device Data

(71) Applicant: Alert GPS Holdings, Corp., South Jordan, UT (US)

(72) Inventor: Russell Scott Thornton, West Jordan, UT (US)

(21) Appl. No.: 13/967,979

(22) Filed: Aug. 15, 2013

(51) Int. Cl. H04W 4/02

(52) U.S. Cl. CPC H04W 4/02
USPC 455/456.3

(57) ABSTRACT

Systems and methods for managing LBS device data are disclosed. In an aspect, one method comprises receiving historical location data associated with a device, determining a weak data of the historical location data, modifying the historical location data to manage the weak data, determining a pattern of one or more locations based on the modified historical location data, determining an out of ordinary rule based upon the determined pattern, receiving a current location data; and generating an alert when the current location data triggers the out of ordinary rule.

### CROSS REFERENCE TO RELATED PATENT APPLICATION

This application claims priority to U.S. patent application Ser. No. 61/683,545 filed Aug. 15, 2012, herein incorporated by reference in its entirety.

### BACKGROUND

Currently available location based services (LBS) tracking systems record LBS data and display location records on maps. The LBS data typically includes one or more of global positioning system (GPS) data, global system for mobile communications (GSM) data, code division multiple access (CDMA) data, Wi-Fi chipset data, assisted GPS (ALPS) data, Synthetic GPS data, Cell ID data, Inertial sensor data, Barometric data, Ultrasonic data, Bluetooth data and Terrestrial Transmitter data, Galileo, GLONASS, mobile operating system LBS methods such as Android and iOS or other systems generating LBS data to estimate a subject device's location. The LBS data is generally processed the same for each new location obtained.

### SUMMARY

It is to be understood that both the following general description and the following detailed description are exemplary and explanatory only and are not restrictive. Provided are methods and systems for managing current and historical LBS data. In an aspect, by determining hourly, daily, weekly, monthly, and or other time-constrained interval patterns in the location data(for example, patterns comprising routes), the accuracy of the data can be significantly improved, future LBS data can be predicted and out of ordinary location data activity can be identified. Location based alerts can then be generated in response to this out of ordinary location data. Ordinary location data can compromise repeated locations, stored locations, designated locations, commonly traveled routes, and/or habitual locations, such as standard consistent locations at certain times of day or night. Out of ordinary location data can comprise a location that is outside of the ordinary location data. As an example, out of ordinary location data can comprise locations that are outside: a commonly traveled daily route, a location that is away from a standard location at a certain e of day or night, and/or a location that is a threshold distance away from a standard location. Out of ordinary data can also have custom configured triggers based on travel and other special user scenarios. Commonality can be defined using thresholds or other settings. As an example, a repeated location or route can be an ordinary location (e.g., common location) or route, respectively. As a further example, a location that is repeated within a given time period can define an ordinary location (e.g., common location).

In an aspect, systems and methods can use historical location data to predict current or future location data, improve accuracy, identify out of ordinary location data and/or generate out of ordinary location based alerts.

In an aspect, the systems and methods of the present disclosure can be applied to improve the accuracy of current location data, predict future location data, estimate location data when the LBS device is off, malfunctions or is unavailable to identify out of ordinary location data and generate out of ordinary location based alerts.

In an aspect, one method for improving the accuracy of the current user data is using historical corresponding LBS data. One of the most common LBS data sources is the combination of GPS, Cell ID and Wi-Fi data. If the current LBS data is missing from one or more specific data source(s), similar historical matching data sources can be substituted to enhance the current accuracy.

In an aspect, one method for improving LBS data is the use of historical data to predict future location data. LBS devices have battery limitations, can break, malfunction, crash, etc. When LBS devices become unavailable, historical data can be used to establish time, LBS source and location based patterns. These patterns provide a basis to predict future location data.

In an aspect, one method for improving LBS data is the use of historical data to identify out of ordinary location data, Based on historical usage, out of ordinary location data can be used to generate out of ordinary alerts.

In an aspect, one method comprises: receiving historical location data associated with a device; determining a weak data of the historical location data; modifying the historical location data to manage the weak data, determining a pattern of one or more locations based on the modified historical location data; determining an out of ordinary rule based upon the determined pattern, receiving a current location data, and generating an alert when the current location data triggers the out of ordinary rule.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary computing device;

FIG. 2 is a system architecture diagram;

FIG. 3 is an exemplary method;

FIG. 4 is an exemplary method;

FIG. 5 is an exemplary method;

FIG. 6 is an exemplary method; and

FIG. 7 is an exemplary method.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Ordinary location data can compromise repeated locations, stored locations, designated locations, common traveled routes, and/or habitual locations such as standard consistent locations at certain times of day or night. Out of ordinary location data can comprise a location that is outside of the ordinary location data. As an example, out of ordinary location data can comprise locations that are outside: a commonly traveled daily route, a location that is away from a standard location at a certain time of day or night, and/or a location that is a threshold distance away from a standard location. Out of ordinary data can also have custom configured triggers based on travel and other special user scenarios. Commonality can be defined using thresholds or other settings. As an example, a repeated location or route can be a common location or route, respectively. As a further example, a location that is repeated within a given time period can define an ordinary location (e.g., common location).

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

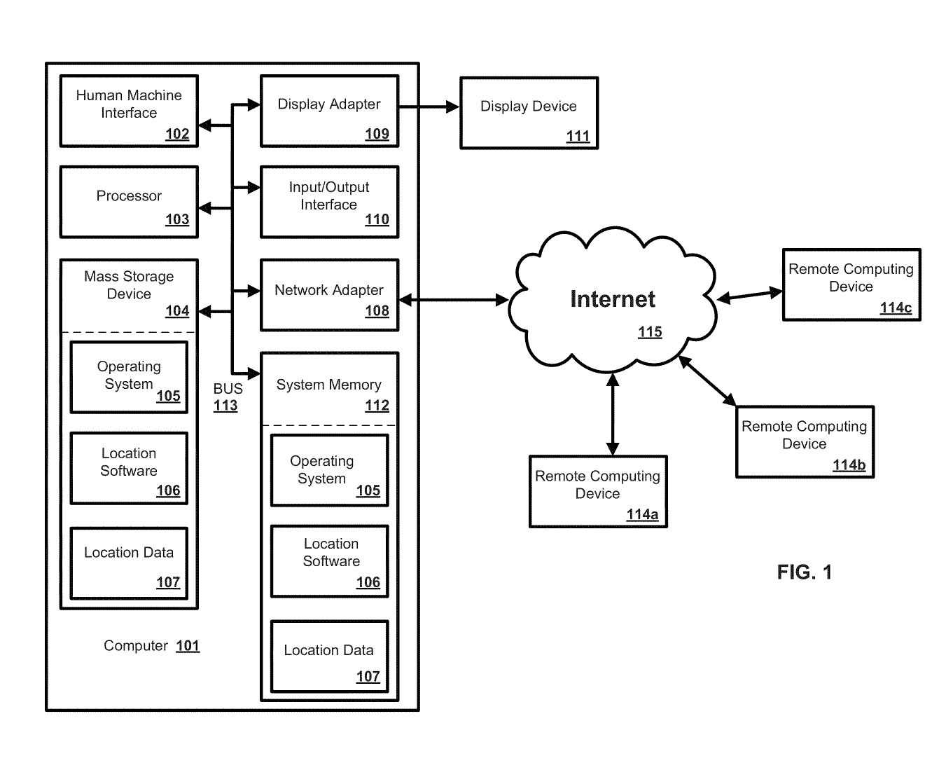

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, location software 106, location data 107, a network adapter 108, system memory 112, an Input/Output Interface 110, a display adapter 109, a display device 111, and a human machine interface 102. can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as location data 107 and/or program modules such as operating system 105 and location software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and location software 106. Each of the operating system 105 and location software 106 (or some combination thereof) can comprise elements of the programming and the location software 106. Location data 107 can also be stored on the mass storage device 104. Location data 107 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of location software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

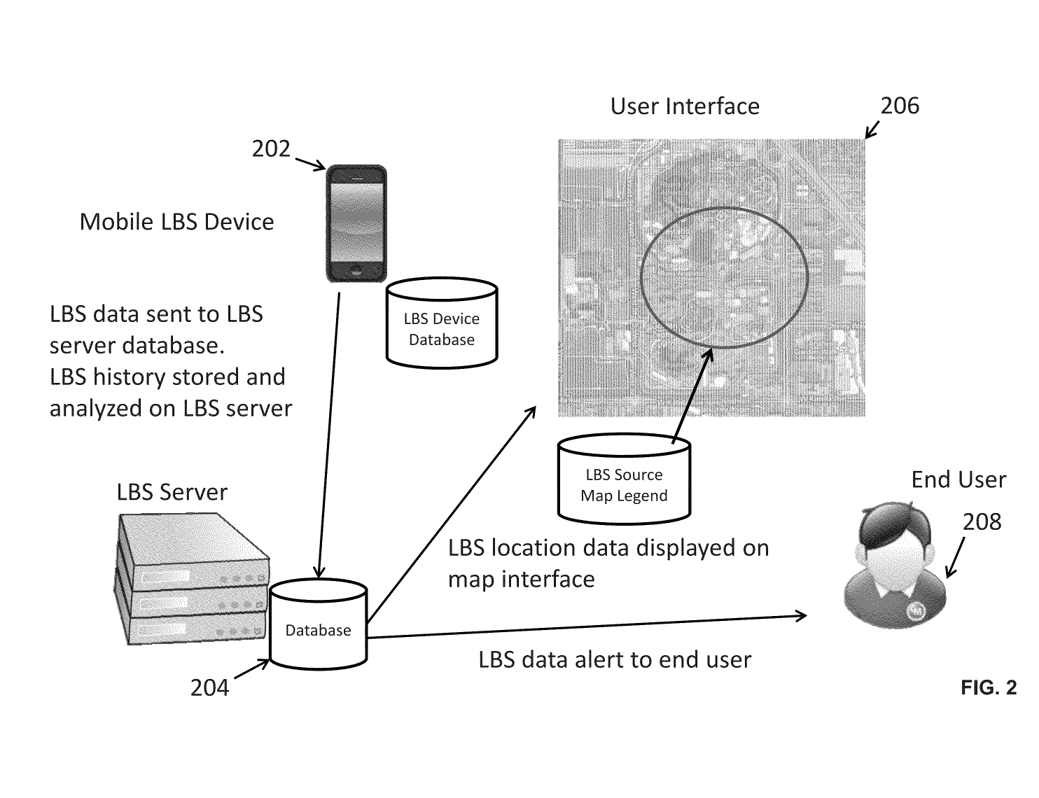

FIG. 2 illustrates an exemplary system. In an aspect, the system can comprise a mobile LBS device 202 (e.g., GPS device, smartphone, computing device, etc.) configured to execute an LBS application and/or receive LBS information. In an aspect, LBS data on the mobile device can be transmitted to an LBS database 204 (e.g., server database). The LBS database 204 can store received data such as LBS data. As an example, historical data such as historical location information can be stored on the LBS database 204. As a further example, data can be analyzed to determine patterns, to determine a source of the data, and to determine a supporting location based logic (e.g., source of the LBS data), which can be used to determine accuracy, radius and integrity of the LBS data. In an aspect, location data can be provided (e.g., rendered, mapped, associated) via an interface 206 such as a map interface. An alert such as an informational message can be sent to one or more users 208. The alert can be associated with a particular LBS data, such as location information.

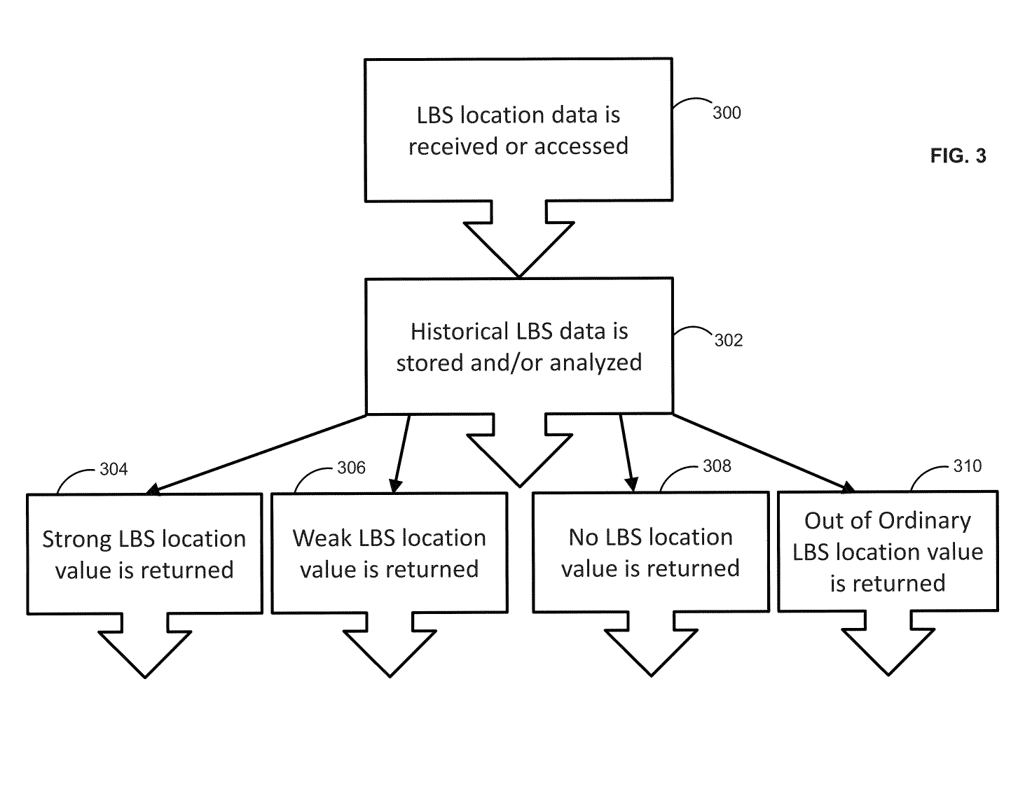

FIG. 3 illustrates an exemplary method according to the present disclosure. In step 300, a device such as an LBS-capable mobile device can process and/or store current LBS data (e.g., location information) and/or can transmit such data to an LBS server or application. As an example, the determined current LBS data can comprise one or more available LBS values from one or more sources such as GPS, Cell ID, Wi-Fi, etc.

In step 302, the LBS server can store historical LBS data (e.g., location information) and can analyze data to determine patterns, user habits, and/or supporting LBS logic. In an aspect, the LBS server or other computing device can determine if the LBS source value is a strong value, at 304. As an example, a quality (e.g., weak or strong, a qualitative metric, a quantitative metric) of a LBS value can be defined by a pre-defined threshold of accuracy, by comparison to other calculated or known values or references, and/or by other metrics used to define accuracy of location. As a further example, a sufficiency of a position (e.g., the LBS value) can be defined by a pre-determined threshold, by comparison to other calculated or known values or references, and/or by other metrics used to define acceptable values of position. The quality of the UPS location data can be determined by the number of satellites in view or the number of consecutive tight (e.g., within predetermined threshold) or close GPS locations over a period of time with similar satellites in view. In the case of Wi-Fi, a quality location is determined by the signal strength over consecutive lookups. Strong values can consist of GPS line of sight with more than 4 satellites. Strong values can comprise values reflecting a direct UPS line of sight with several satellites, WiFi network data with a tight horizontal radius (e.g., 150 feet or less 100 feet or less, 90 feet or less, or some other pre-defined range) the like and/or a combination of UPS, and network data with a horizontal tight radius, for example.

In an aspect, the LBS server or other computing device can determine if the LBS source value is a weak value (e.g., non-strong value, false value, or incomplete value) at 306. As an example, a weak value can comprise Cell ID data with a radius of several miles. As another example, a weak value can comprise network data with a wide horizontal accuracy radius (e.g., over 200 feet, over 300 feet, over 400 feet, over 500 feet, or some other threshold or range) or faulty GPS data with a poor signal to noise ratio (below a defined threshold such as 14).

In an aspect, the LBS server or other computing device can determine if no location data is available at 308. As an example, no information can be classified as a weak value. In an aspect, the LBS server or other computing device can determine if the LBS source value is based on available historical data. In another aspect, the LBS server or other computing device can determine if the location data constitutes an out of ordinary location value, at 310.

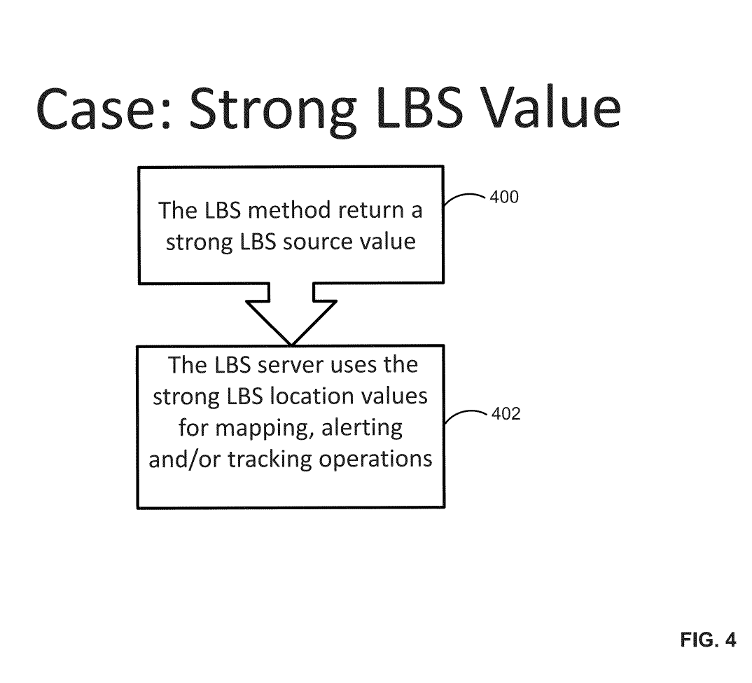

Turning to FIG. 4, at step 400, a strong LBS value can be accessed, received, and/or determined to be available. In an aspect, the LBS server can use the strong LBS location values for standard mapping, alerting, and/or tracking operations, at 402.

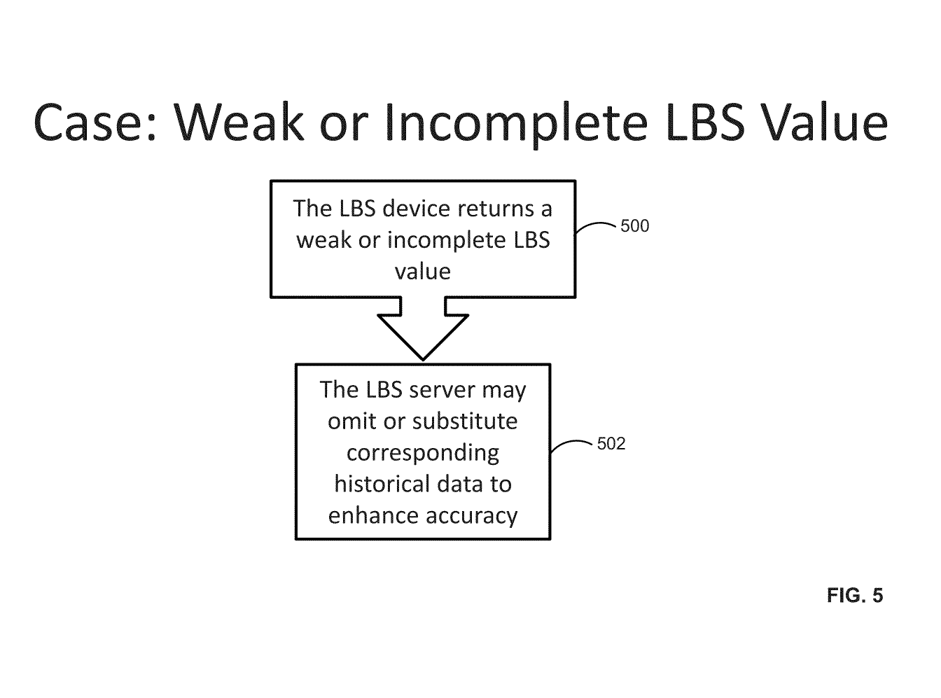

Turning to FIG. 5, at step 500, a weak LBS value can be accessed, received, and/or determined to be available. On an aspect, the LBS server can substitute corresponding historical data for the weak value, at 502. As an example, such a substitution can improve accuracy of location information over the weak value.

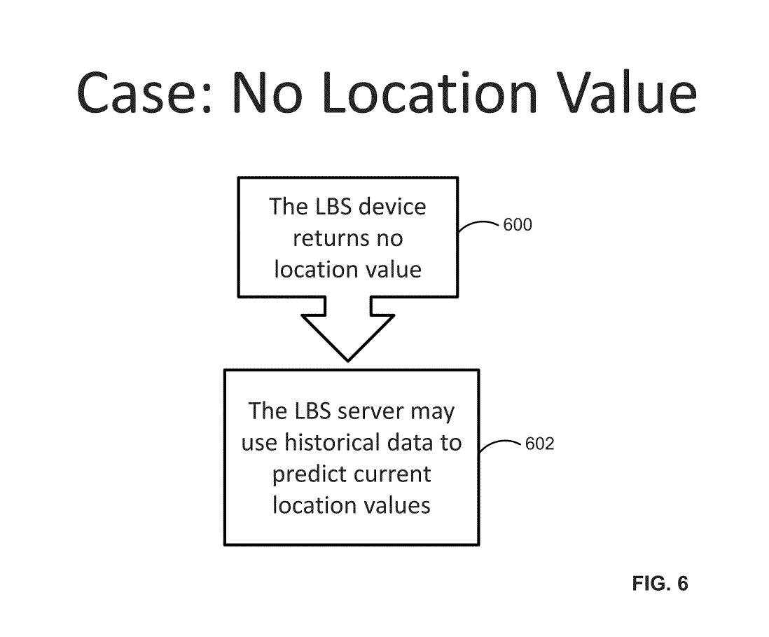

Turning to FIG. 6, at step 600, it can be determined that no location values are received or available. In an aspect, the LBS server can use historical data to determine (e.g., predict) current location values, at 602.

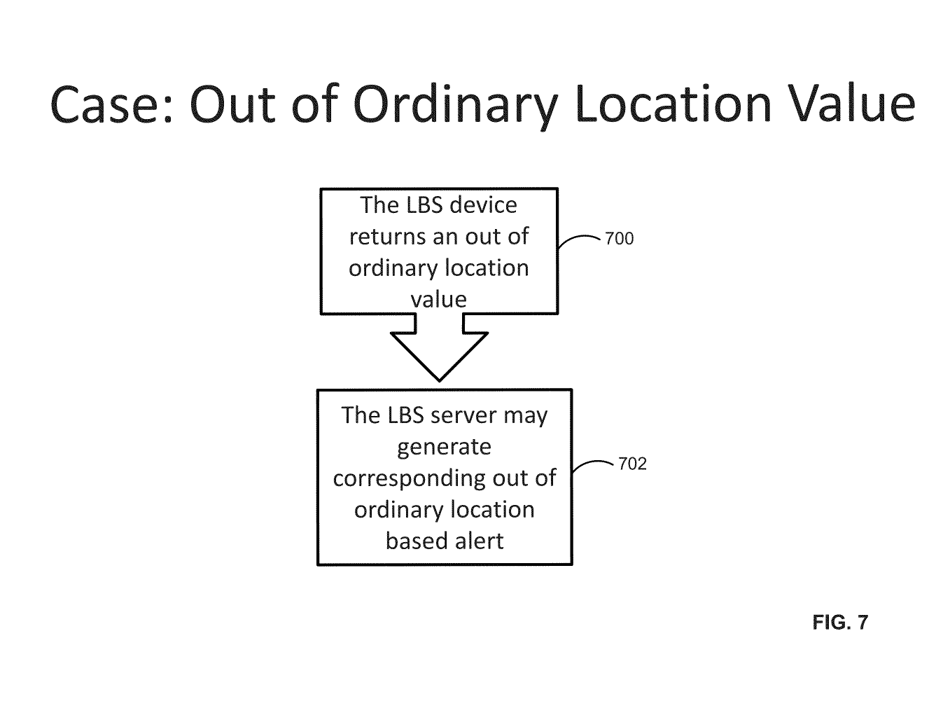

Turning to FIG. 7, at step 700, the LBS device can return an out of ordinary location value. In an aspect, the LBS server can generate one or more corresponding out of ordinary location based alerts at 702. In another aspect, one or more alerts can be generated based on a rule. As an example, the rule can be dependent on parameters such as the age of a user, time of day, historical location patterns, user habits, and/or custom configurations. For example, if a user is a young child (e.g., 5 years of age and younger), then an out of ordinary rule can comprise a distance threshold of one mile from a location (e.g., historical locations, saved locations, ordinary locations). As another example, if the user is a teenage child (e.g., 14-18 years of age), then an out of ordinary rule can comprise a distance threshold of ten miles. As a further example, a default setting (e.g., range of twenty miles) can be associated with a device and/or account. In a further aspect, an out of ordinary rule can comprise a time threshold. For example, a distance threshold can be dependent on a time of day. As another example, during the day, a distance threshold can be set to five miles. However, after 10 p.m., the distance threshold can be reduced to one mile. As a further example, customizable options can be provided to the end user to enable, disable, and set thresholds for distance and times. Feedback from users can be analyzed to update the settings and/or options.

### EXAMPLES

The following examples are put forth so as to provide those of ordinary skill in the art with a complete disclosure and description of how the articles, devices and/or methods claimed herein are made and evaluated, and are intended to be purely exemplary and are not intended to limit the scope of the methods and systems.

Example #1

GPS Accuracy Bounce Issue with Connected Wi-Fi:

The LBS server receives new GPS, Wi-Fi and Cell ID LBS values from the mobile device. The LBS values are compared to historical values for time, date and location patterns. Both the Wi-Fi and Cell ID are comparable to historical data, but the GPS value is significantly different (e.g. by over 300 meters). By determining that the mobile device is currently connected to the Wi-Fi network and the Wi-Fi network has a limited range historically of 200 feet or less, the GPS value is determined to be a false value and can be omitted and or an accurate historical UPS value can be substituted to enhance the accuracy of this location data.

### Example #2

Predicting Future Locations with no Battery Power—Child Stops to Play with Neighborhood Dog on the Way Home From School:

In an aspect, a parent is tracking a child walking home from school. The mobile LBS device has run out of battery power and cannot transmit current LBS data. The LBS server has received no updated LBS data. The child is late has not arrived home from school. The LBS server uses historical data to identify a detour the child takes at similar historical dates and time. The parent locates the child playing with a neighborhood dog on a side street detour route.

### Example #3

Out of Ordinary Location Data & Location Alert—Child is Miles Away from a School Location During a Scheduled School Day:

In an aspect, a child is abducted and taken off school premises. The LBS receives new LBS data from a mobile device. The data is compared to historical data at similar times and dates. The new LBS data shows a location that is several miles away from historical data. The LBS data is labeled as out of ordinary data and an out of ordinary location based alert is generated.

Accuracy and GPS accuracy bounce are significant problems in the LBS industry. LBS device failures and battery limitations are also significant issues. Using historical LBS data to enhance accuracy, predict future location data and identify out of ordinary LBS data can result in superior systems and will greatly benefit end users.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving historical location data associated with a device;
determining a weak data of the historical location data;
modifying the historical location data to manage the weak data;
determining a pattern of one or more locations based on the modified historical location data;
determining an out of ordinary rule based upon the determined pattern;
receiving a current location data; and
generating an alert when the current location data triggers the out of ordinary rule.

2. The method of claim I, wherein the device is a mobile device.

3. The method of claim 1, wherein one or more of the historical location data and the current location data comprises GPS data, GSM systems data, CDMA systems data, Wi-Fi chipset data, ,GPS data, Synthetic GPS data, Cell ID data, Inertial sensor data, Barometric data, Ultrasonic data, Bluetooth data and Terrestrial Transmitter data, Galileo data, and GLONASS data.

4. The method of claim I, wherein determining a pattern of one or more locations comprises determining one or more ordinary locations associated with the device.

5. The method of claim 1, wherein the pattern comprises one or more repeated locations contained in the modified location historical data.

6. The method of claim 1, wherein the out of ordinary rule comprises a threshold range from the determined pattern of one or more locations.

7. The method of claim 1, wherein modifying the historical location data comprises one or more of omitting the determined weak data and substituting a strong value for the determined weak value.

8. A method comprising:
receiving historical location data associated with a device;
determining a weak data of the historical location data;
modifying the historical location data to manage the weak data; and
determining a location of the device based on the modified historical location data.

9. The method of claim 8, wherein the device is a mobile device.

10. The method of claim 8, wherein the historical location data comprises GPS data, GSM systems data, CDMA systems data, Wi-Fi chipset data, AGPS data, Synthetic GPS data, Cell ID data, Inertial sensor data, Barometric data, Ultrasonic data, Bluetooth data and Terrestrial Transmitter data, Galileo data, and GLONASS data.

11. The method of claim 8, wherein determining a weak data comprises determining common historical daily routes, common location for time of day, or common traveled distance for the age of a user from a standard location, or a combination thereof.

12. The method of claim 8, wherein modifying the historical location data comprises omitting the determined weak data.

13. The method of claim 8, wherein modifying the historical location data comprises substituting a strong value for the determined weak value.

14. The method of claim 8, wherein determining a location comprises calculating one of a current location and a predicted future location.

15. A method comprising:
receiving historical location data associated with a device;
determining a pattern of one or more locations based on the historical location data associated with the device;
determining an out of ordinary rule based upon the determined pattern;
receiving a current location data; and
generating an alert when the current location data triggers the out of ordinary rule.

16. The method of claim 15, wherein one or more of the historical location data and the current location data comprises GPS, GSM systems data, CDMA systems data, Wi-Fi chipset data, AGPS data, Synthetic GPS data, Cell ID data, Inertial sensor data, Barometric data, Ultrasonic data, Bluetooth data and Terrestrial Transmitter data, Galileo, and GLONASS.

17. The method of claim 15, wherein determining a pattern of one or more locations comprises determining one or more ordinary locations associated with the device.

18. The method of claim 15, wherein the pattern comprises one or more repeated locations contained in the location historical data.

19. The method of claim 15, wherein the out of ordinary rule comprises a threshold range from the determined pattern of one or more locations.

20. The method of claim 15, further comprising transmitting the alert to indicate that the device is located at an out of ordinary location.
